(19) United States
(12) Patent Application Publication
(10) Pub. No.: US 2022/0407310 A1
(43) Pub. Date: Dec. 22, 2022

(54) INTELLIGENT ENERGY MANAGEMENT SYSTEM FOR DISTRIBUTED ENERGY RESOURCES AND ENERGY STORAGE SYSTEMS USING MACHINE LEARNING

(71) Applicant: Energy Toolbase Software, Inc., Clagary (CA)

(72) Inventors: Jielian Guo, Calgary (CA); Prudhvi Tella, Calgary (CA)

(21) Appl. No.: 17/606,597

(22) PCT Filed: Apr. 26, 2019
(86) PCT No.: PCT/US2019/029438

§ 371 Date: Oct. 26, 2021

(51) Int. Cl. H02J 3/00; H02J 3/32; H02J 7/00

(52) U.S. Cl. CPC H02J 3/003; H02J 3/32; H02J 7/0049; H02J 7/00712; H02J 2203/10; G06N 20/20

(57) ABSTRACT

There is described a method of reserving a capacity of one or more energy storage devices. The method includes forecasting, based on past electricity demand of a site, future electricity demand of the site over a future time period. The method further includes determining a forecasting error between the forecasted future electricity demand and an actual electricity demand of the site over the future time period. The method further includes adjusting, based on the forecasting error, a target state of charge (SOC) of one or more energy storage devices. The method further includes reserving, based on the adjusted target SOC, a capacity of the one or more energy storage devices.

### FIELD OF THE DISCLOSURE

The present disclosure relates to methods and systems for managing electricity demand, and in particular for managing peaks in electricity demand. The disclosure further relates to forecasting production in photovoltaic cells.

### BACKGROUND TO THE DISCLOSURE

Commercial and industrial (C&I) sites pay for power differently when compared to residential sites. In particular, C&I sites are generally billed for both their total energy consumption and their peak power demand, referred to as a “demand charge”. FIG. 1 shows a typical electricity demand profile of a C&I site, also known as a demand charge profile. The profile comprises a substantially steady-state portion 12 and peaks 14 extending from steady-state portion 12 above a demand threshold 16.

Demand charges exist as a mechanism for utilities to cover the costs of delivering the desired level of energy to customers. Each customer is assigned to a particular “rate tariff” which defines how demand charges are measured and assessed for that customer. While details of rate tariffs can vary from utility to utility, the demand charge is generally based on the maximum energy a site consumed during a time interval (for example 15 minutes or 1 hour) during the previous billing cycle.

While there have been many advances in energy efficiency to enable C&I customers to reduce their energy consumption, until recently there have been few technologies for reducing the demand charge component of a customer's incurred cost. Furthermore, while energy prices have remained low in recent years, demand charges have been on the rise and are expected to continue to rise into at least the near future.

This presents the opportunity to minimize the demand charge component of the customer's incurred cost, referred to as “demand charge management”. Not only does demand charge management reduce the customer's electricity bill, but it reduces risks associated with unmanaged peak loads and demand charge price escalation as rate tariffs are updated.

Non-grid electricity supplies, such as energy storage systems, have emerged as a technology which can enable demand charge management through a process known as “peak shaving”. The basic process of peak shaving is accomplished by storing (charging) energy in an energy storage system at times of low energy demand, and discharging the stored energy at times of high energy demand.

The process of creating an accurate prediction of a site's future load is difficult and complex, as energy usage patterns can be highly variable from one site to another, and can vary greatly based on numerous factors including the time of day, the day of the week, the day of the year, weather, building type, work schedule, business processes, etc.

Given the complex nature of accurately forecasting future demand of a site, errors in forecasting may lead to insufficient battery capacity being available to deal with sudden and unexpected demand spikes. Given the possibility of forecasting errors leading to unanticipated demand spikes, it would be advantageous if off-grid electricity supply could be better managed in order to deal with unexpected demand spikes

Still further, in the context of energy demand management of a site, it is known to predict or forecast the production of photovoltaic (PV) cells at the site. PV cells may be used, for example in conjunction with other energy storage devices such as batteries, to provide non-grid energy for meeting demand spikes. Forecasting the production of PV cells is therefore useful for anticipating how much energy may be available from PV cells at the time a demand spike is anticipated.

Forecasting of PV cell production is known to be accomplished using a forecasting model that relies on knowledge of various physical parameters of the PV cells. While such forecasting may be relatively accurate in the absence of cloud cover, this type of forecasting tends to break down when cloud cover increases. It would therefore be advantageous if an improved method of forecasting PV cell production could be provided.

The present disclosure seeks to provide methods and systems that provide improved management of electricity demand charge, and improved methods and systems for forecasting PV cell production, in view of at least some of the deficiencies encountered in the prior art.

### SUMMARY OF THE DISCLOSURE

According to a first aspect of the disclosure, there is provided a method of reserving a capacity of one or more energy storage devices, comprising: forecasting, based on past electricity demand of a site, future electricity demand of the site over a future time period; determining a forecasting error between the forecasted future electricity demand and an actual electricity demand of the site over the future time period; adjusting, based on the forecasting error, a target state of charge (SOC) of one or more energy storage devices; and reserving, based on the adjusted target SOC, a capacity of the one or more energy storage devices.

Adjusting the target SOC may be further based on a current SOC of the one or more energy storage devices.

Adjusting the target SOC may comprise using a proportional-integral-derivative (PID) feedback loop using the current SOC and the forecasting error as inputs to the PID feedback loop.

Reserving the capacity of the one or more energy storage devices may comprise increasing a demand threshold below which an electricity demand of the site is met by one or more grid-based electricity sources, and above which the electricity demand is met by the one or more energy storage devices.

The method may further comprise adjusting the forecasting error based on one or more historical forecasting errors.

The method may further comprise, after increasing the demand threshold: determining that the electricity demand of the site has dropped below the demand threshold; and in response thereto, recharging the one or more energy storage devices. The method may further comprise: determining that the one or more energy storage devices are fully recharged; and in response thereto, decreasing the demand threshold.

Recharging the one or more energy storage devices may comprise recharging the one or more energy storage devices at a maximum rate. Recharging the one or more energy storage devices at a maximum rate may comprise setting the demand threshold equal to the electricity demand of the site.

Increasing the demand threshold may comprise increasing the demand threshold based on a rate of discharge of the one or more energy storage devices.

Increasing the demand threshold may comprise increasing the demand threshold based on a magnitude of the electricity demand.

Forecasting the future electricity demand may comprise: obtaining past electricity demand data representing past electricity demand of the site over a past time period; and forecasting, based on the past electricity demand data, the future electricity demand. The past time period may extend from a past point in time to a current point in time.

Forecasting the future electricity demand may comprise inputting the past electricity demand data to a trained machine learning model comprised in a set of one or more trained machine learning models. The trained machine learning model to which is inputted the past electricity demand data may be selected based on the future time period.

The trained machine learning model may be configured to forecast future electricity demand data for a first time slot that immediately follows a current point in time. The set of trained machine learning models may comprise multiple trained machine learning models, and each other trained machine learning model may be configured to forecast future electricity demand data for a respective time slot that immediately follows a preceding one of the time slots

The method may further comprise, prior to obtaining the past electricity demand data: obtaining electricity demand training data representing electricity demand of the site over a training time period greater than the past time period; and training each machine learning model, using the electricity demand training data, to forecast electricity demand of the site over first time periods as a function of electricity demand of the site over second time periods preceding the first time periods. The electricity demand training data may comprise data representing one or more of: weather; temperature; humidity; atmospheric pressure; months of a year; time of day; dates; days of a week; and whether or not a day of the week is a site holiday.

Each machine learning model may comprise one or more support vector machines or a long short-term memory model.

The past electricity demand data may further comprise data representing one or more of: weather; temperature; humidity; atmospheric pressure; months of a year; time of day; dates; days of a week; and the future time period.

According to a further aspect of the disclosure, there is provided a method of forecasting production of one or more photovoltaic cells, comprising: obtaining past production data of one or more photovoltaic cells, wherein the past production data comprises production data representing, over a past time period, production as a function of weather of the one or more photovoltaic cells; and forecasting, based on the past production data, future production data, wherein the future production data comprises production data representing, over a future time period, future production as a function of future forecasted weather of the one or more photovoltaic cells.

Forecasting the future production data may comprise inputting the past production data to a trained machine learning model comprised in a set of one or more trained machine learning models. The trained machine learning model to which is inputted the past production data may be selected based on the future time period.

The trained machine learning model may be configured to forecast future production data for a first time slot that immediately follows a current point in time.

The set of trained machine learning models may comprise multiple trained machine learning models, and each other trained machine learning model may be configured to forecast future production data for a respective time slot that immediately follows a preceding one of the time slots.

The method may further comprise prior to obtaining the past production data: obtaining production training data representing production of the one or more photovoltaic cells over a training time period greater than the past time period; and training each machine learning model, using the production training data, to forecast, as a function of future forecasted weather: production of the one or more photovoltaic cells over first time periods as a function of production of the one or more photovoltaic cells over second time periods preceding the first time periods. The production training data may comprise data representing one or more of: weather; cloud cover; intensity of sunlight; temperature; humidity; atmospheric pressure; amount of precipitation; type of precipitation; wind speed; wind gusts; months of a year; time of day; dates; days of a week.

Each machine learning model may comprise one or more support vector machines or a long short-term memory model.

The past production data may further comprise data representing one or more of: weather; cloud cover; intensity of sunlight; temperature; humidity; atmospheric pressure; months of a year; time of day; dates; days of a week; and the future time period.

According to a further aspect of the disclosure, there is provided a method of forecasting production of one or more photovoltaic cells, comprising: forecasting, according to one of a first and a second forecasting model, future production of one or more photovoltaic cells over a future time period; determining a forecasting error between the forecasted future production and an actual production of the one or more photovoltaic cells over the future time period; and determining, based on the forecasting error, whether to transition the forecasting to the other of the first and second forecasting models.

Forecasting according to the first forecasting model may comprise forecasting future production based on one or more physical parameters of the one or more photovoltaic cells. The one or more physical parameters may comprise one or more: a size; an orientation; a type; a quantity; a model; an azimuth; a tilt; a latitude; a longitude; and an elevation.

The method may further comprise transitioning the forecasting to the other of the first and second forecasting models in response to determining that the forecasting error is greater than a preset threshold.

Forecasting according to the second forecasting model may comprise forecasting future production based on past production of the one or more photovoltaic cells as a function of weather. Forecasting according to the second forecasting model may further comprise forecasting future production further based on one or more physical parameters of the one or more photovoltaic cells. The forecasting of the future production based on past production of the one or more photovoltaic cells as a function of weather is further may be based on an output of the forecasting of the future production based on the one or more physical parameters of the one or more photovoltaic cells.

Forecasting according to the second forecasting model may further comprise: obtaining past production data representing, over a past time period, past production of the one or more photovoltaic cells as a function of weather; and forecasting, based on the past production data, future production data representing, over a future time period, future production as a function of future forecasted weather of the one or more photovoltaic cells. Forecasting the future production may comprise inputting the past production data to a trained machine learning model comprised in a set of one or more trained machine learning models. The trained machine learning model to which is inputted the past production data may be selected based on the future time period.

The trained machine learning model may be configured to forecast future production data for a first time slot that immediately follows a current point in time.

The set of trained machine learning models may comprise multiple trained machine learning models, and each other trained machine learning model may be configured to forecast future production data for a respective time slot that immediately follows a preceding one of the time slots

The method may further comprise, prior to obtaining the past production data: obtaining production training data representing production of the one or more photovoltaic cells as a function of weather over a training time period greater than the past time period; and training each machine learning model, using the production training data, to forecast, as a function of future forecasted weather: production of the one or more photovoltaic cells over first time periods as a function of production of the one or more photovoltaic cells over second time periods preceding the first time periods. The production training data may further comprise data representing one or more of: weather; cloud cover; intensity of sunlight; temperature; humidity; atmospheric pressure; months of a year; time of day; dates; days of a week.

Each machine learning model may comprise one or more support vector machines or a long short-term memory model.

The past production data may further comprise data representing one or more of: weather; cloud cover; intensity of sunlight; temperature; humidity; atmospheric pressure; months of a year; time of day; dates; days of a week; and the future time period.

According to a further aspect of the disclosure, there is provided a method of training a machine learning model, the method comprising: receiving at a machine learning model production training data representing, over a training time period, past production of one or more photovoltaic cells as a function of weather; and training the machine learning model, using the production training data, to forecast, as a function of future forecasted weather: production of the one or more photovoltaic cells over first time periods as a function of production of the one or more photovoltaic cells over second time periods preceding the first time periods.

According to a further aspect of the disclosure, there is provided a demand management system for managing electricity demand, the system comprising: one or more energy storage devices, such as one or more photovoltaic cells and/or one or more batteries; and a control system comprising one or more processors and memory having stored thereon computer program code configured, when executed by the one or more processors, to cause the one or more processors to perform any of the above-described methods.

According to a further aspect of the disclosure, there is provided a computer-readable medium having stored thereon computer program code configured, when executed by one or more processors, to cause the one or more processors to perform any of the above-described methods.

### BRIEF DESCRIPTION OF THE DRAWINGS

Detailed embodiments of the disclosure will now be described in connection with the accompanying drawings of which:

FIG. 1 shows a typical demand charge profile of a commercial/industrial site;

FIG. 2 is a schematic diagram of a power management system in accordance with an embodiment of the disclosure;

FIG. 3 is a more detailed schematic diagram of the power management system of FIG. 2;

FIG. 4 is an example of a long short-term memory model in accordance with embodiments of the disclosure;

FIG. 5 is a flow diagram showing a method of managing electricity demand, in accordance with an embodiment of the disclosure;

FIGS. 6A and 6B are examples of feature vectors in accordance with embodiments of the disclosure; and

FIG. 7 is a schematic diagram of a system for reserving battery capacity, according to embodiments of the disclosure;

FIG. 8 is a flow diagram of a method of reserving battery capacity, according to embodiments of the disclosure;

FIG. 9 is a plot of actual electricity demand vs. forecasted electricity demand;

FIGS. 10 and 11 show plots of actual electricity demand, forecasted electricity demand, a demand threshold, a metered load, aggregated state-of-charge, and target state-of-charge, according to embodiments of the disclosure;

FIG. 12 is a flow diagram of a method for forecasting photovoltaic cell production, according to embodiments of the disclosure;

FIG. 13 is a flow diagram of a method for forecasting photovoltaic cell production, according to embodiments of the disclosure; and

FIG. 14 is a plot of actual PV cell production vs. forecasted PV cell production, according to embodiments of the disclosure.

### DETAILED DESCRIPTION

The present disclosure seeks to provide methods and systems for managing electricity demand, and for forecasting production of photovoltaic cells. While various embodiments of the disclosure are described below, the disclosure is not limited to these embodiments, and variations of these embodiments may well fall within the scope of the disclosure which is to be limited only by the appended claims.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through one or more intermediate elements or devices via an electrical element, electrical signal or a mechanical element depending on the particular context. The term “and/or” herein when used in association with a list of items means any one or more of the items comprising that list.

As will be appreciated by one skilled in the art, the various example embodiments described herein may be embodied as a method, system, or computer program product. Accordingly, the various example embodiments may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the various example embodiments may take the form of a computer program product on a computer-usable storage medium having computer-usable program code embodied in the medium.

Any suitable computer-usable or computer readable medium may be used. The computer-usable or computer-readable medium may be, for example but not limited to, an electronic, magnetic, optical, electromagnetic, infrared, or semiconductor system, apparatus, device, or propagation medium. In the context of this document, a computer-usable or computer-readable medium may be any medium that can contain, store, communicate, propagate, or transport the program for use by or in connection with the instruction execution system, apparatus, or device.

Computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or entirely on the remote computer or server. In the latter scenario, the remote computer may be connected to the computer through a local area network (LAN) or a wide area network (WAN), or the connection may be made to an external computer (for example, through the Internet using an Internet Service Provider).

Various example embodiments are described below with reference to flow diagrams and/or block diagrams of methods, apparatus (systems) and computer program products according to example embodiments. It will be understood that each block of the flow diagrams and/or block diagrams, and combinations of blocks in the flow diagrams and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow diagram and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flow diagram and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flow diagram and/or block diagram block or blocks.

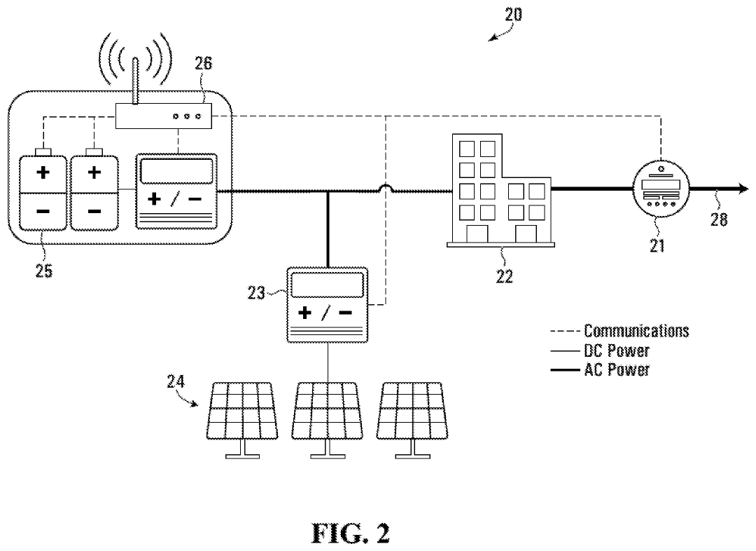

With reference to FIG. 2, there is shown a demand management system 20 used for managing electricity demand of a site 22, in accordance with an embodiment of the disclosure. Site 22 is electrically coupled to photovoltaic cells 24 via one or more inverters 23. Site 22 is further electrically coupled to an electricity grid 28 configured to provide electricity on demand to site 22. One or more meters 21 are configured to monitor a consumption of electricity at site 22. Site 22 is further coupled to an energy management system processor 26 (described in further detail below) and batteries 25 configured to provide stored electrical energy to site 22. Batteries 25 are further electrically coupled to photovoltaic cells 24 for recharging of batteries 25.

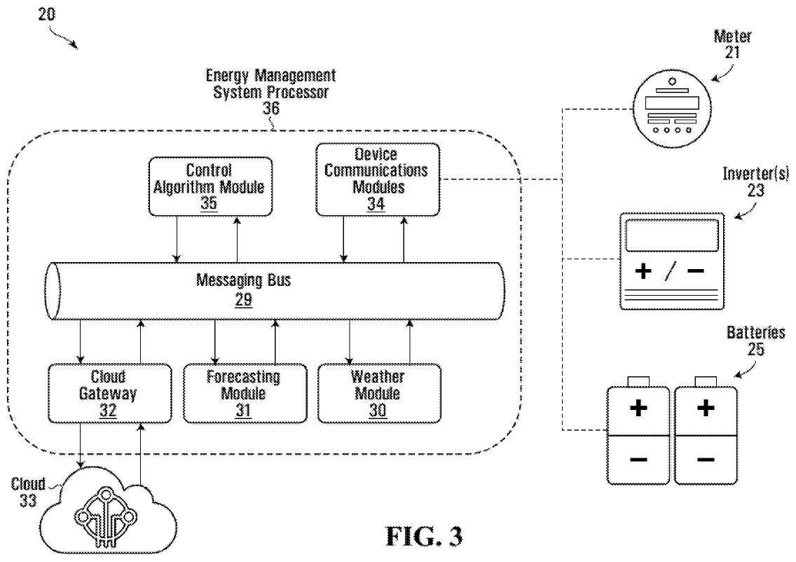

FIG. 3 shows another schematic representation of demand management system 20, this time showing communicative pathways between the various components of demand management system 20. Meters 21, inverters 23, and batteries 25 are communicatively coupled to one or more device communications modules 34 such that data from meters 21, inverters 23, and batteries 25 may be communicated to a messaging bus 29 via device communications modules 34. Also communicatively coupled to messaging bus 29 are a weather module 30 and a forecasting module 31. Energy management system processor 26 is seen to comprise a control algorithm module 35, device communications modules 34, cloud gateway 32, forecasting module 31, weather module 30, and messaging bus 29, although in other embodiments it shall be understood that energy management system processor 26 may comprise more or fewer modules.

Data from weather module 30 and forecasting module 31 may be transmitted along messaging bus 29 to control algorithm module 35. The data transmitted from weather module 30 comprises any weather-related data which may have been forecasted by weather module 30 using methods known to those of skill in the art, or which may have been provided directly to weather module 30 without weather module 30 performing the forecasting of the weather. Control algorithm module 35 comprises one or more processors communicative with memory having computer program code stored thereon. The program code is configured, when executed by the one or more processors, to perform any of the methods described herein. In particular, control algorithm module 35 is configured to implement one or more peak shaving algorithms, as described herein. Control algorithm module 35 may use data received from other components of demand management system 20, such as inverters 23, batteries 25, and forecasting module 31, in order to effectively implement the one or more peak shaving algorithms. Forecasting module 31 contains a machine learning model that is used for forecasting a future load (i.e. projected or expected electricity usage) at site 22, as described in further detail below.

In order to manage the electricity demand at site 22, control algorithm module 35 communicates with forecasting module 31 which is configured to apply a trained machine learning model to a set of past demand data in order to forecast a future load at site 22. The past demand data comprises, amongst other data, past electricity usage data at site 22. As described below, the machine learning model is trained using demand training data which comprises electricity usage training data. The machine learning model may be trained by forecasting module 31 itself or alternatively the trained machine learning model may be downloaded to forecasting module 31, for example via cloud gateway 32 communicating with an external cloud 33. Thus, the machine learning model may be trained externally to demand management system 20, and subsequently obtained by control algorithm module 35 through forecasting module 31.

The machine learning model may be any machine learning model suitable for the purposes described herein. In some embodiments, the machine learning model is a support vector regression (SVR) model. In other embodiments, the machine learning model is a long short-term memory (LSTM) model. Examples of an SVR model and an LSTM model that may be employed by forecasting module 31 are described below.

In a supervised regression problem, the training data is taken as {(x₁, y₁, . . . , (xₗ, yₗ)}⊂ [symbol] × [symbol] where [symbol] denotes the space of the input patterns, for instance [symbol] ^{d}. In ϵ−SV regression, the goal is to find a function f (x) that has at most ϵ deviation from the actually obtained targets yᵢ for all the training data, and which is at the same time as flat as possible. In the case of a linear function f,

f(x)=<ω, x>+b with ω∈ [symbol] b∈ [symbol] (1),

where <.,. > denotes the dot product in N. Flatness in (1) implies small co. In order to achieve flatness, it is required to minimize the Euclidean norm ∥ω∥². Formally, this can be written as a convex optimization problem by requiring:

minimize ½∥ω∥²

$$subject to \{ \begin{matrix}{y}_{i} - 〈 ω , {x}_{i} 〉 - b \leq ε \\ 〈 ω , {x}_{i} 〉 + b - {y}_{i} \leq ε\end{matrix} . \qquad ( 2 )$$

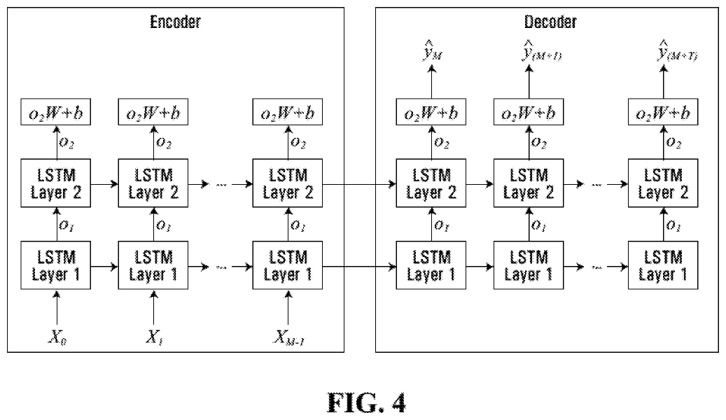

An example LSTM model is shown in FIG. 4. In FIG. 4, Xᵢ is a feature vector, and ŷ9ᵢ is forecasted electricity usage. In the embodiment of FIG. 4, an example feature vector Xᵢ inputted to an LSTM model comprises past electricity usage y at time step i-1, weather at time step i, and date and time at time step i, as per the following:

Xᵢ=[yᵢ₋₁, weatherᵢ, date timeᵢ]

In order to train the machine learning model, a set of demand training data is used as an input to the machine learning model. The demand training data comprises data representing past electricity usage at site 22. The past electricity usage may be determined for example by periodically obtaining meter readings from meters 21. In addition to past electricity usage, the demand training data comprises data representing a number of other different parameters related to electricity usage at site 22 over a period of time. For example, the demand training data may comprise data representing any prevailing weather conditions at site 22, for example temperature, humidity, date and time information (for example information relating to time of day, day of the week, month, and whether not a day is a site holiday). Other parameters may form part of the demand training data. The demand training data is preferably obtained over a relatively long period of time, for example two years.

Inputting the demand training data to the machine learning model trains the machine learning model to forecast electricity usage at site 22 as a function of past electricity usage at site 22. In other words, the machine learning model is able to determine possible relationships between past electricity usage (including past weather conditions and date/time information) and future electricity usage, by analyzing the demand training data to determine trends within the demand training data. Once the machine learning model has been trained using the electricity usage training data, the trained machine learning model may be used to forecast future electricity usage at site 22, by using known, past demand usage data.

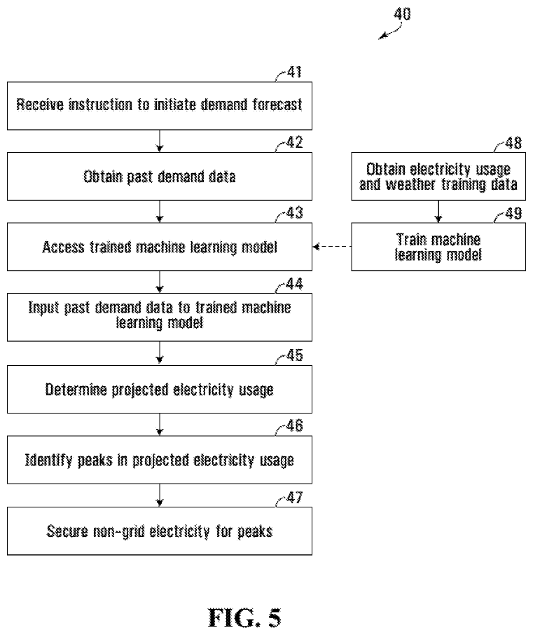

FIG. 5 is a flowchart showing operations that may be taken by energy management system processor (EMSP) 36 in managing electricity demand at site 22, by performing an electricity demand management method 40. At block 41, EMSP 36 receives an instruction from a user of demand management system 20 to initiate a demand forecast, by performing electricity demand management method 40. The instruction specifies a future time period over which forecasting module 31 is to forecast future electricity usage. At block 42, EMSP 36 obtains past demand data. The past demand data comprises past electricity usage data representing past electricity usage at site 22. The past electricity usage data may be obtained for example by periodically obtaining meter readings from meters 21. In addition to past electricity usage data, the past demand data comprises data representing a number of other different parameters related to electricity usage at site 22 over a period of time. For example, the past demand data comprises data representing any prevailing weather conditions at site 22, temperature (for example temperature of batteries 25 as well as ambient temperature), atmospheric humidity, atmospheric pressure, and date and time information representing the particular future time period the user wishes to forecast. Other parameters may form part of the past demand data.

In some embodiments, the past demand data represents data over a one-week period. In addition, the period of time corresponding to the past demand data extends from a past point in time to a current point in time. In other words, the period of time corresponding to the past demand data extends from a past point in time to the point in time at which EMSP 36 is instructed to carry out electricity demand management method 40. Thus, the past demand data may be obtained from a “rolling window” as time goes forward. In this manner, more recent demand data may be used as an input to the machine learning model, thereby improving the accuracy of the forecast.

At block 43, EMSP 36 accesses the trained machine learning model. As described above, the trained machine learning model may be downloaded to EMSP 36. Alternatively, the trained machine learning model may be stored on a device or devices external to EMSP 36, such that EMSP 36 sends the past demand data to the external device or devices for inputting to the trained machine learning model, and receives from the external device or devices output from the trained machine learning model. Blocks 48 and 49 represent respectively obtaining the demand training data, as described above, and training the machine learning model using the demand training data.

At block 44, the past demand data is inputted to the trained machine learning model. At block 45, the trained machine learning model outputs projected electricity usage data representing projected electricity usage at site 22 for the future time period selected by the user.

In some embodiments, the user may request a forecast of the expected or projected electricity usage at site 22 for any amount of time up to the following 24 hours, with a granularity of 15 minutes. Of course, in other embodiments the forecast may be extended to longer or smaller time horizons, with greater or smaller granularities. In order to perform the forecasting, in one embodiment the trained machine learning model uses 96 support vector machine (SVR) models. Each SVR model is configured to forecast projected electricity usage for a specific future time slot (i.e. a specific 15-minute tranche). For example, the first SVR model is used to forecast the immediately subsequent 15 minutes; in other words, the 15 minutes that follow the point in time that EMSP 36 is instructed to perform the forecast. The second SVR model is used to forecast the 15-30 minute time slot; in other words, the 15 minutes that follow a point in time 15 minutes after EMSP 36 is instructed to perform the forecast; etc. By integrating multiple ones of 96 forecasts of the 96 SVR models, a forecast horizon of 24 hours with 15-minute granularity may be generated. As mentioned above, the number of SVR models can be tuned to forecast for different time horizons, and with different granularity, and thus any number of SVR models may in practice be used to forecast projected electricity usage.

The past demand data is represented using feature vectors as described below. Let d denote the current day and j-1 denote the current time. The first SVR model is used to forecast the electricity usage of day d at time j-1+1. The second SVR model is used to forecast the electricity usage of day d at time j-1+2. More generally, the m^{th} SVR model is used to forecast the electricity usage of day d at time j-1+m. Each feature vector comprises data relating to one or more of the parameters identified above. For example, in addition to past electricity usage, each feature vector may comprise data relating to prevailing weather conditions at site 22, temperature (for example temperature of batteries 25 as well as ambient temperature), atmospheric humidity, atmospheric pressure, and date and time information representing the particular future time period the user wishes to forecast.

An example feature vector is shown below:

| | | | | | | | | |
|---|---|---|---|---|---|---|---|---|
| Load | cooling | heating | extra | humidity | day of | month | holiday | period to |
| | | | heating | | week | | | be forecasted |

Take for example the past electricity usage of the m^{th} SVR model. The m^{th} SVR model uses as an input the load (past electricity usage) of time (j-1+m). Thus, [load(0), load(1), , load(15)] may be the load of day d-7 at time (j-1+m)-6, (j-1+m)-5, . . . , (j-1+m), (j-1+m)+1, . . . , (j-1+m)+9.

[load(16), load(17)] may be the load of day d-3 at time (j-1+m)-1, (j-1+m).

[load(18), load(19)] may be the load of day d-2 at time (j-1+m)-1, (j-1+m).

[load(20), load(21), . . . , load(25)] may be the load of day d-1 at time (j-1+m)-6, . . , (j-1+m)-1, (j-1+m).

[load(26), load(27), . . . , load(121)] may be the load of day d at time j-96, j-95, . . . , j-2, j-1 (i.e. all the load/past electricity usage information of the past 24 hours).

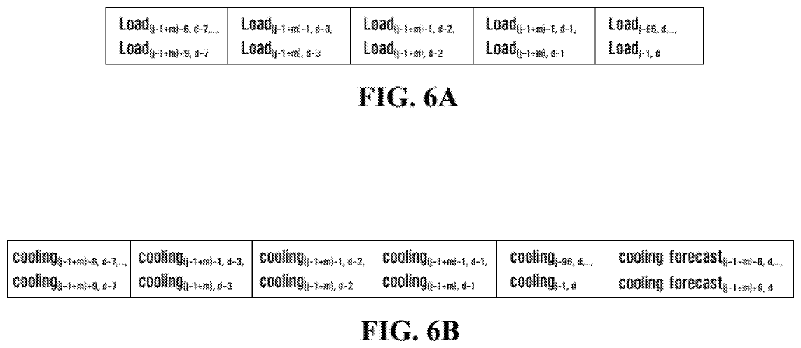

Examples of load and cooling data in feature vectors are shown in FIGS. 6A and 6B. Note that as mentioned above the feature vectors may comprise data relating to additional parameters (not shown in FIGS. 6A and 6B).

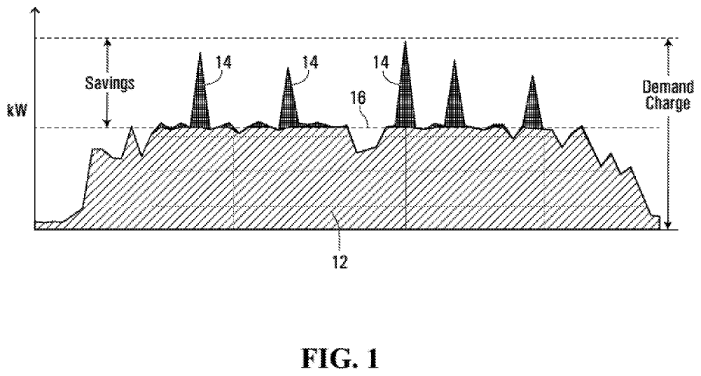

Once EMSP 36 has performed the forecast, at block 46, EMSP 36 identifies one or more peaks in the projected electricity usage. The peaks may be identified by comparing the projected electricity usage to an electricity demand threshold (for example electricity demand threshold 16 as can be seen in FIG. 1). There are various methods known in the art for identifying such peaks.

At block 47, EMSP 36 transmits one or more instructions for securing non-grid electricity for managing the projected electricity demand. In particular, EMSP 36 transmits one or more instructions for securing non-grid electricity for use during the future periods corresponding to the identified peaks. Non-grid electricity may be derived from various distributed energy/electricity resources, such as batteries 25 and/or photovoltaic cells 24, or other on-site energy generation (such as combined heat and power generation, or from a diesel/gas generator). During relatively steady-state electricity usage (such as during the period corresponding to steady-state demand 12 in FIG. 1), grid-based electricity may be used when needed. However, during periods of peak power demand (such as during the periods corresponding to peaks 14 in FIG. 1), electricity from non-grid sources may be used so as to reduce the overall cost to the site owner.

EMSP 36 may be configured to take into account current electricity reserves in non-grid sources, such as in batteries 25 and/or photovoltaic cells 24, before determining from which non-grid source(s) to draw stored electricity so as to perform peak shaving. Furthermore, EMSP 36 may use the past demand data to determine the non-grid source for use during the periods of peak demand. In particular, the past demand data may also comprise data representing battery and photovoltaic cell storage over a past time period. Using the trained machine learning model, EMSP 36 may determine from the past demand data projected battery and photovoltaic cell storage over a future time period. Thus, by using past battery and photovoltaic cell storage data, EMSP 36 may predict future battery and photovoltaic cell storage. This information may be used by EMSP 36 to better anticipate from which non-grid source electricity is to be used for shaving the peaks, based on the amount of stored electricity in the non-grid sources.

EMSP 36 may further comprise different optimization routines for securing the non-grid electricity. Individual optimization routines may be selected by a user as a function of what is desired to be achieved. For example, if it is necessary to shave the peaks as much as possible without concern for completely draining the non-grid electricity sources, then EMSP 36 may be configured to instruct the drawing of as much electricity as allowable from batteries 25 and photovoltaic cells 24 during the peak demand periods. Alternatively, if it is important to reserve some non-grid electricity in case a sudden unexpected peak demand occurs, then EMSP 36 may be configured to instruct the drawing of no more than a certain, preset amount of electricity from batteries 25 and/or photovoltaic cells 24 during the peak demand periods.

Reserving Battery Capacity

According to embodiments of the disclosure, it may be desirable to reserve a capacity of batteries 25, in order to mitigate the effect of unforeseen demand spikes. For example, errors in forecasting by forecasting module 31 may result in the failure to anticipate or predict one or more future demand spikes and thereby potentially expose the user to additional demand charges. In order to ensure that there remains some capacity within batteries 25 in order to meet such unforeseen demand spikes, embodiments of the disclosure provide methods and systems that reserve a capacity of batteries 25, as now described in further detail.

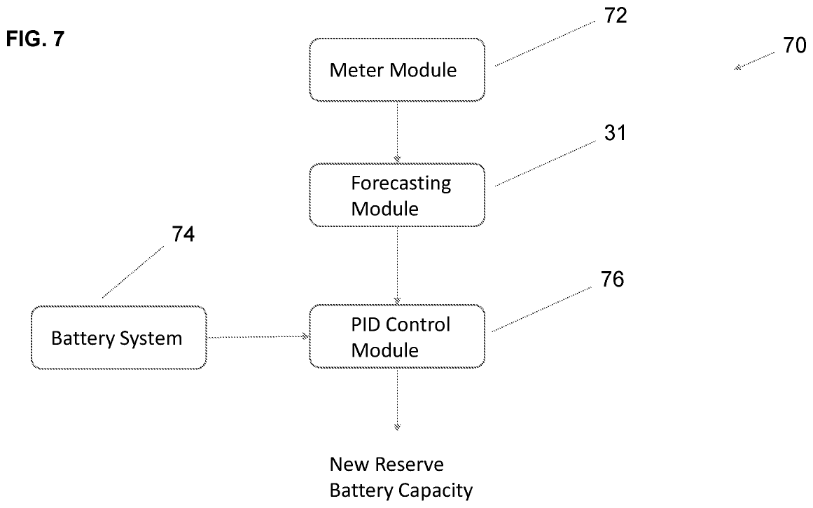

Turning to FIG. 7, there is shown an example of a system 70 for reserving a capacity of batteries 25. System 70 includes a meter module 72, forecasting module 31 (which may be the same forecasting module 31 seen in FIG. 3), a battery system 74, and a proportional-integral-derivative (PID) control module 76 (which, according to some embodiments, may be control algorithm module 35 of FIG. 3). Meter module 72 obtains meter data (for example data relating to historical electricity demand) from meters 21 and provides the data to forecasting module 31. As described in more detail below, forecasting module 31 is configured to determine a forecasting error and provide the forecasting error to PID control module 76. Battery system 74 obtains battery data (for example data relating to a current state-of-charge (SOC)) from batteries 25 and provides the battery data to PID control module 76. PID control module 76 uses the forecasting error and the current SOC provided by battery system 74 to determine a capacity of batteries 25 that is to be reserved, as now described in more detail. According to some embodiments, data relating to energy stored in other renewable energy sources (such as photovoltaic cells) may also be provided to PID control module 76 (for example by using data obtained from inverters 23). Such data may additionally be used by PID control module 76 to determine a capacity of energy that is to be reserved in such other renewable energy sources.

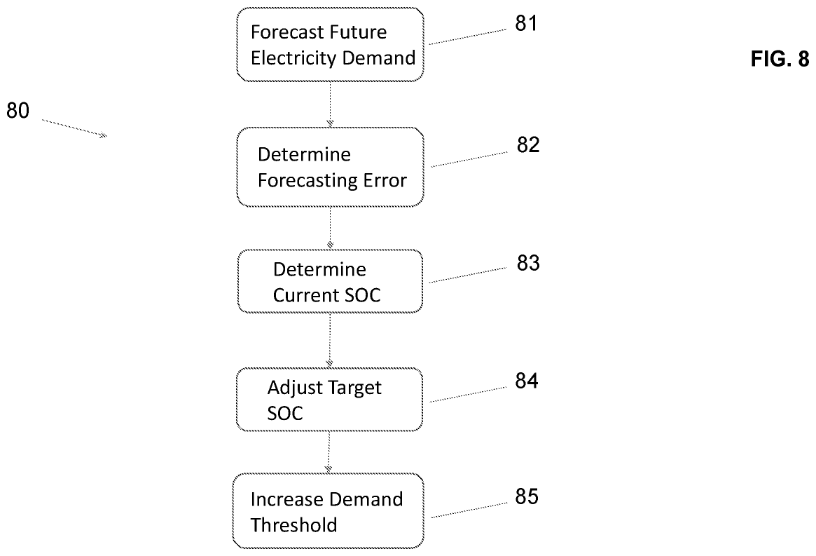

Turning to FIG. 8, there is shown a method 80 of reserving battery capacity, according to embodiments of the disclosure.

At block 81, future electricity demand of site 22 is forecasted. The future electricity demand may be forecasted using any of the above methods described in connection with FIGS. 2-6B. For example, forecasting module 31 may be configured to apply a trained machine learning model to a set of past demand data obtained from meter module 72, in order to forecast a future load at site 22. The past demand data comprises, amongst other data, past electricity usage data at site 22. The machine learning model is trained using demand training data which comprises electricity usage training data. The machine learning model may be trained by forecasting module 31 itself or alternatively the trained machine learning model may be downloaded to forecasting module 31, for example via cloud gateway 32 communicating with an external cloud 33. Thus, the machine learning model may be trained externally to demand management system 20, and subsequently obtained by forecasting module 31.

The machine learning model may be any appropriate machine learning model suitable for the purposes described herein. In some embodiments, the machine learning model may be a support vector regression (SVR) model. In other embodiments, the machine learning model may be a long short-term memory (LSTM) model. Examples of an SVR model and an LSTM model that may be employed by forecasting module 31 are described above in connection with FIG. 4.

In order to train the machine learning model, a set of demand training data is used as an input to the machine learning model. The demand training data comprises data representing past electricity usage at site 22. The past electricity usage may be determined for example by periodically obtaining meter readings from meters 21. In addition to past electricity usage, the demand training data comprises data representing a number of other different parameters related to electricity usage at site 22 over a period of time. For example, the demand training data may comprise data representing any prevailing weather conditions at site 22, for example temperature, humidity, date and time information (for example information relating to time of day, day of the week, month, and whether not a day is a site holiday). Other parameters may form part of the demand training data. The demand training data is preferably obtained over a relatively long period of time, for example two years.

Inputting the demand training data to the machine learning model trains the machine learning model to forecast electricity usage at site 22 as a function of past electricity usage at site 22. In other words, the machine learning model is able to determine possible relationships between past electricity usage (including past weather conditions and date/time information) and future electricity usage, by analyzing the demand training data to determine trends within the demand training data. Once the machine learning model has been trained using the electricity usage training data, the trained machine learning model may be used to forecast future electricity usage at site 22, by using known, past demand usage data.

Using the past demand usage data, forecasting module 31 forecasts future demand usage at site 22, using the methods described above in connection with FIG. 5.

Returning to FIG. 8, at block 82, forecasting module 31 determines a forecasting error. The forecasting error may be an error between the forecasted future electricity demand of site 22 and an actual electricity demand of site 22, over the same time period. In other words, the forecasting error is indicative of the inaccuracy of the forecast of the future electricity demand. The forecasting error may be adjusted based on one or more historical forecasting errors. For example, the forecasting error determined for a period during which electricity demand tends to be unpredictable may be adjusted based on one or more historical forecasting errors determined in the past for similar periods of time (e.g. for similar times of day during which electricity demand tends to be unpredictable). The forecasting error is transmitted to PID control module 79.

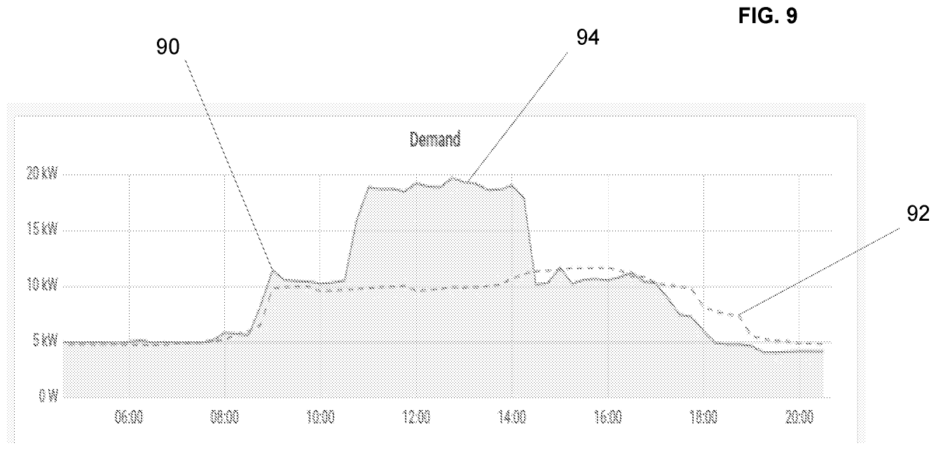

Turning to FIG. 9, there is shown a plot of actual demand 90 and forecasted demand 92 over time. As can be seen, forecasted demand 90 fails to anticipate a demand spike 94, leading to a significant forecasting error during the period of demand spike 94.

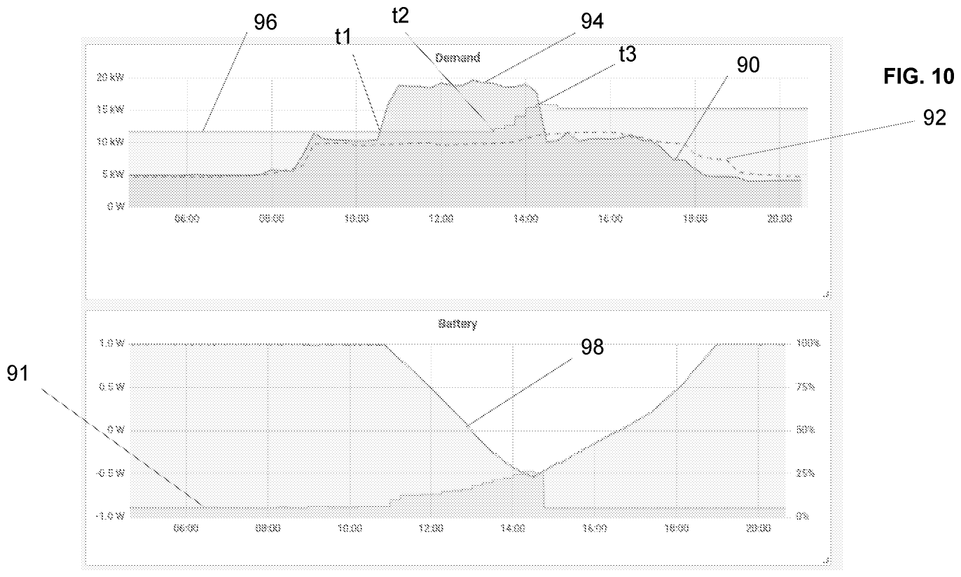

Returning to FIG. 8, at block 83, PID control module 76 obtains from battery system 74 the current SOC of batteries 25. At block 84, PID control module 76 uses a PID feedback to adjust a target SOC of batteries 25. At block 85, based on the updated target SOC, PID control module 76 adjusts the demand threshold (the threshold above which electricity demand is met by non grid-based sources). For example, if the target SOC is increased, then the demand threshold is increased, thereby reserving a capacity of batteries 25. Conversely, if the target SOC is decreased, then the demand threshold is decreased, and thereby a greater proportion of demand is met through non grid-based sources, such as batteries 25 (which generally reduces the user's exposure to increased demand charges). An example of the effect of method 80 is now illustrated in connection with FIGS. 10 and 11.

Turning to FIG. 10, there is shown the plot of FIG. 9 with a demand threshold 96 overlaid thereon. In addition, there is shown a plot of aggregated SOC 98 of batteries 25 and target SOC 91 as a function of time. Target SOC 91 begins at a nominal 5% (according to other embodiments, target SOC 91 may begin at other values) and, as described in further detail below, may increase as the difference between actual electricity demand 90 and forecasted demand 92 increases. Thus, battery reserve is generally used as much as possible to meet electricity demand until uncertain loads are observed in which case battery reserve is increased in order to better manage the uncertain loads. A higher forecasting error indicates lower confidence in the forecast, and thus system 70 hedges against the uncertainty by reserving some battery capacity for future use.

At time t1, actual electricity demand 90 exceeds demand threshold 96, resulting in aggregated SOC 98 of batteries 25 reducing (i.e. batteries 25 begin to discharge) in order to meet the increase in electricity demand. Furthermore, at approximately t1, the forecasting error begins to increase as actual electricity demand 90 exceeds more and more forecasted demand 92. Thus, using method 80 described above, PID control module 74, in response to detecting the increase in forecasting error, causes target SOC 91 to increase. The increase in target SOC 91 causes demand threshold 96 to begin increasing at time t2. A lag exists between the increase in target SOC 91 and the increase in demand threshold 96. For example, PID control module 74 may cause demand threshold 96 to increase only after identifying a trend in the forecasting error. As demand spike 94 ends, at time t3 the demand drops below demand threshold 96, and the demand is then met by grid-based sources as described above, allowing batteries 25 to be recharged as can be seen by aggregated SOC 98 in the lower plot. In addition, as actual demand 90 approaches forecasted demand 92, the forecasting error decreases, resulting to PID control module 76 decreasing target SOC 91.

Thus, by increasing demand threshold 96 in response to an increase in forecasting error and/or a decrease in the current SOC of batteries 25, a greater proportion of electricity demand is met by grid-based sources, ensuring an increased reserve of battery capacity for any unexpected demand peaks that may occur in the future.

FIG. 11 shows the same demand profile as that of FIG. 10 but additionally shows the metered demand 97 of the system (i.e. the grid-based electricity demand). The total electricity demand or consumption 90 is therefore the sum of metered demand 97 and the power output 99 of batteries 25. In the embodiment of FIG. 11, as demand spike 94 causes electricity demand 90 to increase above the demand threshold (not shown but corresponding to metered demand 97), batteries 25 begin to discharge at time t1, as seen by trace 98 (representing the aggregated SOC 98 of batteries 25). As the demand threshold increases, and as demand spike 94 abates, batteries 25 begin charging at t3 (when electricity demand 90 drops below the demand threshold). As electricity demand 90 remains below the demand threshold, batteries 25 charge at a maximum rate while keeping metered demand 97 at or below the demand threshold. In the case of FIG. 11, from t3 until the end of the charging, metered demand 97 is kept at the demand threshold.

As can be seen from FIG. 11, during recharging of batteries 25, the demand threshold is set to metered demand 97, in order for batteries 25 to be recharged as quickly as possible. A slower charging rate is also possible, but the system is preferably configured to recharge batteries 25 as quickly as possible (without exceeding the demand threshold), to thereby provide maximum battery reserve in as short an amount of time as possible. This may enable a user to better manage future unexpected demand spikes with reserve battery capacity. The demand threshold may be generally set to be the maximum monthly metered load.

Improved Photovoltaic Cell Forecasting

According to embodiments of the disclosure, the production of photovoltaic (PV) cells 24 may be forecasted using the above-described SVR model. In certain cases, such forecasting may represent an improvement over traditional methods of forecasting PV cell production. Such traditional methods generally rely on forecasting based on one or more physical parameters of the PV cells. While this may provide accurate forecasting during periods of good weather, i.e. with minimal or no cloud cover, the accuracy of such forecasting may decrease as cloud cover increases and it becomes more difficult to accurately predict future production of the PV cells.

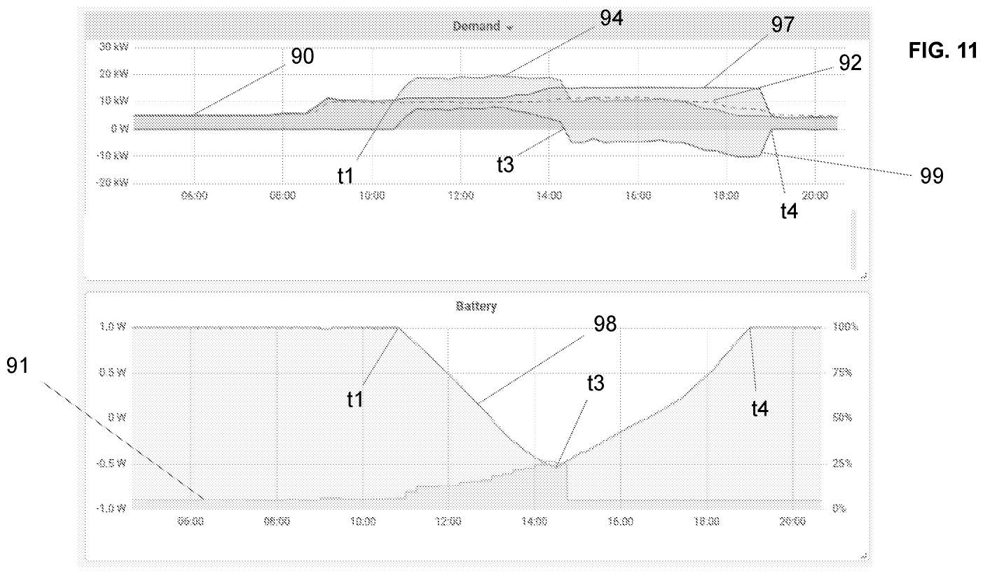

Turning to FIG. 12, there is shown a method of forecasting PV cell production, according to embodiments of the disclosure.

At block 122, forecasting module 31 obtains PV cell production training data, to be used in training a machine learning model. The machine learning model may be trained by forecasting module 31 itself or alternatively the trained machine learning model may be downloaded to forecasting module 31, for example via cloud gateway 32 communicating with an external cloud 33. Thus, the machine learning model may be trained externally to demand management system 20, and subsequently obtained by forecasting module 31. The machine learning model may be any machine learning model suitable for the purposes described herein. In some embodiments, the machine learning model is a support vector regression (SVR) model. In other embodiments, the machine learning model is a long short-term memory (LSTM) model. Examples of an SVR model and an LSTM model that may be employed by forecasting module 31 are described above in connection with FIG. 4.

At block 124, the machine learning model is trained. In order to train the machine learning model, the PV cell production training data is used as an input to the machine learning model. The PV cell production training data comprises data comprises data relating to historical PV cell production as a function of prevailing weather. The historical PV cell production may be determined for example by periodically obtaining readings from inverters 23. In addition to historical PV cell production data, the PV cell production training data comprises data related to prevailing weather conditions at site 22 during the period corresponding to the historical PV cell production. For example, such weather data may include data relating to cloud cover, intensity of sunlight, temperature, humidity, atmospheric pressure, amount of precipitation, type of precipitation, wind speed, wind gusts, months of a year, time of day, dates, and days of a week. Other parameters may form part of the PV cell production training data. The weather data may be provided by a third-party source. The PV cell production training data is preferably obtained over a relatively long period of time, for example two years.

Inputting the PV cell production training data to the machine learning model trains the machine learning model to forecast PV cell production at site 22 as a function of past PV cell production at site 22. In other words, the machine learning model is able to determine possible relationships between past PV cell production as a function of weather, and future PV cell production as a function of future forecasted weather, by analyzing the PV cell production training data to determine trends within the PV cell production training data. Once the machine learning model has been trained using the PV cell production training data, the trained machine learning model may be used to forecast future PV cell production at site 22, by using known, past PV cell production data.

At block 126, past PV cell production data is obtained. At block 128, forecasting module 31 returns the forecasted PV cell production, by inputting the past PV cell production data to the trained machine learning model. In order to forecast PV cell production, any of the methods described above in connection with FIG. 5 may be used.

In particular, demand management system 20 first receives an instruction from a user to initiate a PV cell production forecast. The instruction specifies a future time period over which forecasting module 31 is to forecast PV cell production. The period of time corresponding to the past PV cell production extends from a past point in time to a current point in time. In other words, the period of time corresponding to the past PV cell production extends from a past point in time to the point in time at which EMSP 36 is instructed to perform the forecasting. Thus, the past PV cell production data may be obtained from a “rolling window” as time goes forward. In this manner, more recent PV cell production data may be used as an input to the machine learning model, thereby improving the accuracy of the forecast.

The past PV cell production data is inputted to the trained machine learning model, and at block 128 the trained machine learning model outputs projected PV cell production data representing projected PV cell production at site 22 for the future time period selected by the user.

In some embodiments, the user may request a forecast of the expected or projected PV cell production at site 22 for any amount of time up to the following 24 hours, with a granularity of 15 minutes. Of course, in other embodiments the forecast may be extended to longer or smaller time horizons, with greater or smaller granularities. In order to perform the forecasting, in one embodiment the trained machine learning model uses 96 support vector machine (SVR) models. Each SVR model is configured to forecast projected electricity usage for a specific future time slot (i.e. a specific 15-minute tranche). For example, the first SVR model is used to forecast the immediately subsequent 15 minutes; in other words, the 15 minutes that follow the point in time that EMSP 36 is instructed to perform the forecast. The second SVR model is used to forecast the 15-30 minute time slot; in other words, the 15 minutes that follow a point in time 15 minutes after EMSP 36 is instructed to perform the forecast; etc. By integrating multiple ones of 96 forecasts of the 96 SVR models, a forecast horizon of 24 hours with 15-minute granularity may be generated. As mentioned above, the number of SVR models can be tuned to forecast for different time horizons, and with different granularity, and thus any number of SVR models may in practice be used to forecast projected electricity usage.

Thus, according to method 120, a machine learning model may be used to better forecast PV cell production. In particular, past PV cell production as a function of weather may be used to forecast future PV cell product as a function of future forecasted weather.

According to further embodiments of the disclosure, forecasting module 31 may be configured to forecast PV cell production according to more than one forecasting model, and may be configured to transition between multiple forecasting models. In particular, forecasting module 31 may be configured to transition between a first forecasting module, in which forecasting is performed according to one or more physical parameters of PV cells 24, and a second forecasting model, in which forecasting is performed based at least partially on historical data relating to past PV cell production as a function of weather.

The one or more physical parameters of the first forecasting model may include PV cell type, PV cell quantity, PV cell model, azimuth, tilt, latitude, longitude, and elevation. The first forecasting model may use any of the methods described in Stein, Joshu S, et al, “PVLIB: Open Source Photovoltaic Performance Modeling Functions for Matlab and Python”, Sandia National Lab. (SNL-NM), Albuquerque, N.M. (United States), May 1, 2016, which is herein incorporated by reference in its entirety.

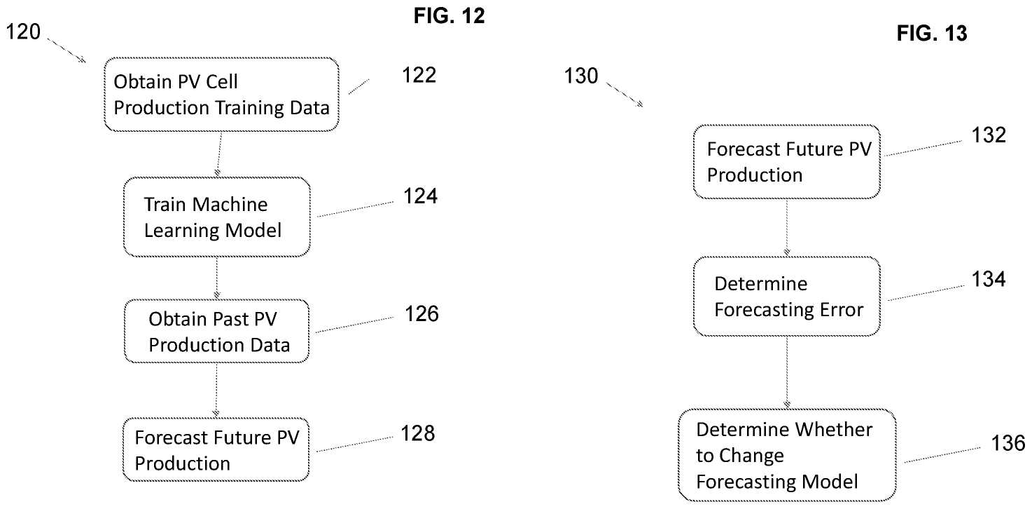

Turning to FIG. 13, according to embodiments of the disclosure, there is shown a method of forecasting PV cell production based on multiple forecasting models.

At block 132, forecasting module 31 forecasts future PV cell production according to the first forecasting model. For example, forecasting module 31 forecasts future PV cell production using any of the methods described in PVLIB: Open Source Photovoltaic Performance Modeling Functions for Matlab and Python. At block 134, forecasting module 31 determines a forecasting error between the forecasted PV cell production and actual PV cell production. If the forecasting error becomes too large, then at block 136 forecasting module 31 may determine that the current (first) forecasting model is ineffectively forecasting PV cell production. Thus, forecasting module 31 may transition from the first forecasting model to the second forecasting model.

For example, as described above, the first forecasting model which relies on physical parameters of PV cells 25 is generally accurate to the extent that cloud cover is nonexistent or minimal. If cloud cover increases sufficiently, the forecasting error will increase until forecasting module 31 determines that forecasting should now proceed on the basis of the second forecasting model. According to the second forecasting model, PV cell production is forecasted according to a hybrid approach of the first, physical forecasting model and the machine learning-based model described above in connection with FIG. 12. Thus, according to the second forecasting model, PV cell production is forecasted based on a combination of one or more physical parameters of PV cells 25 (using for example the methods described in PVLIB: Open Source Photovoltaic Performance Modeling Functions for Matlab and Python) and historical data relating to past PV cell production of PV cells 25 as a function of weather. In particular, PV cell production is first forecasted based on one or more physical parameters of PV cells 25. Subsequently, the output of the forecasting according to the first forecasting model is then used as an input to the machine learning-based model described above in connection with FIG. 12.

According to the second, hybrid forecasting model, the forecasting error may be small when there is significant cloud cover. However, when cloud cover decreases sufficiently, the forecasting error will increase, and the forecasting module 31 may then transition back to the first forecasting model.

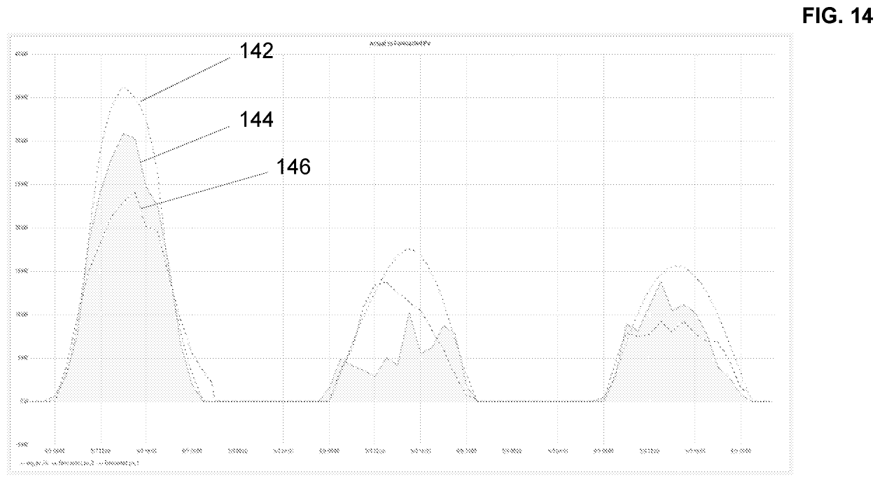

FIG. 14 shows an example plot of actual PV cell production 144, forecasted PV cell production 142 based on the first, physical forecasting model, and forecasted PV cell production 146 based on the second, hybrid forecasting model. FIG. 14 shows that the second, hybrid forecasting model provides an improved method for estimating PV cell production.

While the disclosure has been described in connection with specific embodiments, it is to be understood that the disclosure is not limited to these embodiments, and that alterations, modifications, and variations of these embodiments may be carried out by the skilled person without departing from the scope of the disclosure. For example, it is contemplated that the electricity management system may be configured to control the energy demand of individual energy-demanding devices at the site, so as to better manage the energy demand curve. It is furthermore contemplated that any part of any aspect or embodiment discussed in this specification can be implemented or combined with any part of any other aspect or embodiment discussed in this specification.

1. A method of reserving a capacity of one or more energy storage devices, comprising:
forecasting, based on past electricity demand of a site, future electricity demand of the site over a future time period;
determining a forecasting error between the forecasted future electricity demand and an actual electricity demand of the site over the future time period;
adjusting, based on the forecasting error, a target state of charge (SOC) of one or more energy storage devices; and
reserving, based on the adjusted target SOC, a capacity of the one or more energy storage devices.

2. (canceled)

3. (canceled)

4. The method of claim 1, wherein reserving the capacity of the one or more energy storage devices comprises increasing a demand threshold below which an electricity demand of the site is met by one or more grid-based electricity sources, and above which the electricity demand is met by the one or more energy storage devices.

5. (canceled)

6. The method of claim 4, further comprising, after increasing the demand threshold:
determining that the electricity demand of the site has dropped below the demand threshold; and
in response thereto, recharging the one or more energy storage devices.

7. The method of claim 6, further comprising:
determining that the one or more energy storage devices are fully recharged; and
in response thereto, decreasing the demand threshold.

8. (canceled)

9. (canceled)

10. (canceled)

11. The method of claim 1, wherein the past time period extends from a past point in time to a current point in time.

12. The method of claim 11, wherein forecasting the future electricity demand comprises inputting the past electricity demand data to a trained machine learning model comprised in a set of one or more trained machine learning models.

13. (canceled)

14. (canceled)

15. (canceled)

16. (canceled)

17. (canceled)

18. (canceled)

19. The method of claim 11, wherein the past electricity demand data further comprises data representing one or more of: weather; temperature; humidity;
atmospheric pressure; months of a year; time of day; dates; days of a week; and the future time period.

20. A demand management system for managing electricity demand, the system comprising:
one or more energy storage devices; and
a control system comprising one or more processors and memory having stored thereon computer program code configured, when executed by the one or more processors, to cause the one or more processors to perform a method comprising:
forecasting, based on past electricity demand of a site, future electricity demand of a site over a future time period;
determining a forecasting error between the forecasted future electricity demand and an actual electricity demand of the site over the future time period;
adjusting, based on the forecasting error, a target state of charge (SOC) of the one or more energy storage devices; and
reserving, based on the adjusted target SOC, a capacity of the one or more energy storage devices.

21. (canceled)

22. (canceled)

23. The system of claim 20, wherein reserving the capacity of the one or more energy storage devices comprises increasing a demand threshold below which an electricity demand of the site is met by one or more grid-based electricity sources, and above which the electricity demand is met by the one or more energy storage devices.

24. (canceled)

25. The system of claim 23, wherein the method further comprises, after increasing the demand threshold:
determining that the electricity demand of the site has dropped below the demand threshold; and
in response thereto, recharging the one or more energy storage devices.

26. The system of claim 25, wherein the method further comprises:
determining that the one or more energy storage devices are fully recharged; and
in response thereto, decreasing the demand threshold.

27. (canceled)

28. (canceled)

29. The system of claim 20, wherein forecasting the future electricity demand comprises:
obtaining past electricity demand data representing past electricity demand of the site over a past time period; and
forecasting, based on the past electricity demand data, the future electricity demand.

30. (canceled)

31. The system of claim 29, wherein forecasting the future electricity demand comprises inputting the past electricity demand data to a trained machine learning model comprised in a set of one or more trained machine learning models.

32. (canceled)

33. (canceled)

34. (canceled)

35. (canceled)

36. (canceled)

37. (canceled)

38. The system of claim 29, wherein the past electricity demand data further comprises data representing one or more of: weather; temperature; humidity; atmospheric pressure; months of a year; time of day; dates; days of a week; and the future time period.

39. A computer-readable medium having stored thereon computer program code configured, when executed by one or more processors, to cause the one or more processors to perform a method comprising:
forecasting, based on past electricity demand of a site, future electricity demand of a site over a future time period;
determining a forecasting error between the forecasted future electricity demand and an actual electricity demand of the site over the future time period;
adjusting, based on the forecasting error, a target state of charge (SOC) of one or more energy storage devices; and
reserving, based on the adjusted target SOC, a capacity of the one or more energy storage devices.

40. (canceled)

41. (canceled)

42. The computer-readable medium of claim 39, wherein reserving the capacity of the one or more energy storage devices comprises increasing a demand threshold below which an electricity demand of the site is met by one or more grid-based electricity sources, and above which the electricity demand is met by the one or more energy storage devices.

43. (canceled)

44. The computer-readable medium of claim 42 wherein the method further comprises, after increasing the demand threshold:
determining that the electricity demand of the site has dropped below the demand threshold; and
in response thereto, recharging the one or more energy storage devices.

45. The computer-readable medium of claim 44, wherein the method further comprises:
determining that the one or more energy storage devices are fully recharged; and
in response thereto, decreasing the demand threshold.

46. (canceled)

47. (canceled)

48. The computer-readable medium of claim 39, wherein forecasting the future electricity demand comprises:
obtaining past electricity demand data representing past electricity demand of the site over a past time period; and
forecasting, based on the past electricity demand data, the future electricity demand.

49. (canceled)

50. The computer-readable medium of claim 48, wherein forecasting the future electricity demand comprises inputting the past electricity demand data to a trained machine learning model comprised in a set of one or more trained machine learning models.

51-135. (canceled)
